(19) United States
(12) Patent Application Publication
(10) Pub. No.: US 2014/0370801 A1
(43) Pub. Date: Dec. 18, 2014

(54) METHOD AND APPARATUS FOR A DEVICE TO CONTROL TRANSMISSIONS OF SAFETY MESSAGES FROM OTHER VEHICLES

(71) Applicant: QUALCOMM Incorporated, San Diego, CA (US)

(72) Inventors: Sichao YANG, Basking Ridge, NJ (US); Sundar SUBRAMANIAN, Bridgewater, NJ (US); Xinzhou WU, Hillsborough, NJ (US); Junyi LI, Chester, NJ (US)

(21) Appl. No.: 13/917,451

(22) Filed: Jun. 13, 2013

(51) Int. Cl. H04H 20/55; H04H 20/08

(52) U.S. Cl. CPC H04H 20/55; H04H 20/08
USPC 455/3.01

(57) ABSTRACT

A method, an apparatus, and a computer program product for wireless communication are provided. The apparatus receives a first BSM from a first wireless communication device, determines control information associated with the first BSM, and transmits the first BSM to at least a second wireless communication device based on the determined control information.

### BACKGROUND

1. Field

The present disclosure relates generally to communication systems, and more particularly, to a method and apparatus for a device to control transmissions of safety messages from other vehicles.

2. Background

Dedicated short-range communications (DSRC) is a two-way short-to-medium-range wireless communications capability that permits very high data transmission critical in communications-based active safety applications. For example, DSRC may be implemented using the IEEE 802.11p standard, which adds wireless access in vehicular environments (WAVE) and may support Intelligent Transportation Systems (ITS) applications.

DSRC includes a basic safety message (BSM) format which may be used by vehicles to send and receive BSMs. For example, a vehicle may transmit a BSM to periodically announce its position, velocity and other attributes to other vehicles. The other vehicles may then receive the BSM and track the position of the transmitting vehicle and, therefore, may avoid collisions and improve traffic flow.

DSRC may also allow vehicles to communicate with roadside units (RSUs) to receive urgent public safety data through roadside alert messages. Therefore, a vehicle may largely rely on roadside alert messages from RSUs to detect any public safety issues, such as hazardous road conditions or police activity. However, there may be circumstances where RSUs may not completely cover a particular area or may not be functional. Consequently, a vehicle may not be able to receive the previously discussed urgent public safety data.

### SUMMARY

In an aspect of the disclosure, a method, a computer program product, and an apparatus are provided. The apparatus receives a first BSM from a first wireless communication device, determines control information associated with the first BSM, and transmits the first BSM to at least a second wireless communication device based on the determined control information.

### BRIEF DESCRIPTION OF THE DRAWINGS

FIG. 1 is a diagram illustrating a communication system.

FIG. 2 is a diagram illustrating BSM transmissions.

FIG. 3 is a flow chart of a method of wireless communication.

FIG. 4 is a conceptual data flow diagram illustrating the data flow between different modules/means/components in an exemplary apparatus.

FIG. 5 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

In situations where vehicles cannot communicate with RSUs to receive urgent public safety information, vehicles may need to receive urgent public safety information from BSMs transmitted from other nearby vehicles. In accordance with the aspects described herein, for example, a police vehicle may be configured to use a vehicle of a motorist in traffic as a relay for disseminating information relating to a nearby police pursuit to other nearby vehicles. As another example, an ambulance may use the vehicle of a motorist as a relay for disseminating yield information to other nearby vehicles. As another example, a vehicle may receive road construction and detour information relayed from other vehicles.

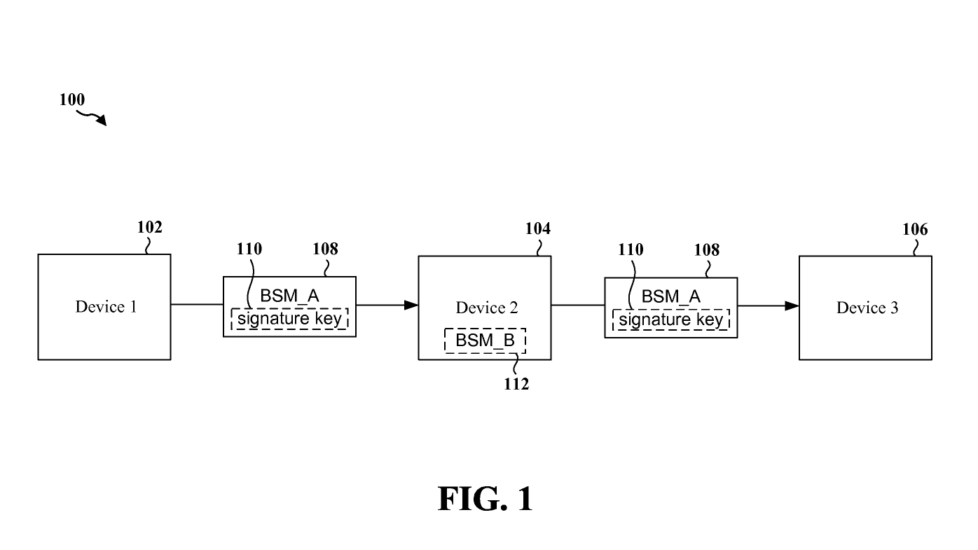

FIG. 1 is a diagram illustrating a communication system 100. As shown in FIG. 1, the communication system 100 includes device 1 102, device 2 104, and device 3 106. In an aspect, the device 1 102, device 2 104, and device 3 106 may each be a wireless communication device configured to transmit and receive messages based on DSRC protocols. In such aspect, the device 1 102, device 2 104, and device 3 106 may each be installed in a different vehicle.

As shown in FIG. 1, the device 1 102 may send a BSM 108 (referred to as “BSM_A” in FIG. 1) to device 2 104. The device 2 104 may receive the BSM 108 and determine control information associated with the BSM 108. For example, the control information may include public safety information, traffic delay information, detour information, a desired transmission direction, a destination, and/or weather information. As further shown in FIG. 1, the device 2 104 may then transmit the BSM 108 to the device 3 106 based on the determined control information. For example, if the control information indicates that the current weather conditions include heavy snowfall, the device 2 104 may transmit the BSM 108 to the device 3 106 with increased transmission power to successfully deliver the BSM 108 to the device 3 106 in such weather conditions. As another example, if the control information indicates that the BSM 108 is to be transmitted to a particular destination, such as a nearby school, the device 2 104 may transmit the BSM 108 to a wireless communication device (e.g., device 3 106) situated at such destination. Therefore, the device 2 104 may relay the BSM 108 received from device 1 102 to device 3 106 based on the control information.

In an aspect, the device 2 104 may determine a relative location of one or more devices (e.g., device 3 106). For example, the device 2 104 may determine the relative location of a device using position information received in a BSM from the device. The device 2 104 may then transmit the BSM 108 to one or more devices based on the relative locations of the devices. For example, the relative location may be represented as GPS coordinates or as a direction with respect to the device 2 104, such as north or southwest.

In an aspect, the device 1 102 may be granted authority to generate BSMs (also referred to as “controlled BSMs”, “enhanced BSMs” or “high priority BSMs”) having a higher priority than BSMs generated by devices that have not been granted such authority. For example, the authority to generate high priority BSMs may be granted to government entities, such as police departments. A wireless communication device that receives and authenticates a high priority BSM may be said to be granted local authority.

In one example scenario, if the device 1 102 is granted authority to generate a high priority BSM, the device 2 104 may receive the BSM 108 from the device 1 102 and not transmit the received BSM 108 to other wireless communication devices (e.g., device 3 106) unless the BSM 108 has been authenticated by the device 2 104. In one configuration, the device 2 104 may authenticate the BSM 108 by validating a signature key 110 inserted in the BSM 108 by the device 1 104. For example, the signature key 110 may be in the form of a bit string. In one configuration, the device 2 104 may validate the signature key 110 of the BSM 108 by comparing a key stored in a memory (not shown in FIG. 1) of the device 2 104 with the signature key 110. If the key stored in the memory of the device 2 104 matches the signature key 110, the device 2 104 may determine that the BSM 108 is a validated BSM. Accordingly, the device 2 104 may then transmit the BSM 108 to one or more devices, such as device 3 106, after the BSM 108 has been authenticated. It should be noted that upon authenticating the BSM 108, the device 2 104 may be said to be granted local authority.

In an aspect, the device 2 104 may generate a BSM 112 (referred to as “BSM_B” in FIG. 1) for transmission to one or more devices (e.g., device 3 106). In such aspect, if the device 2 104 has authenticated the BSM 108 received from the device 1 102, the device 2 104 may transmit the BSM 108 to device 3 106 prior to transmitting the BSM 112. Therefore, in such aspect, the device 2 104 may prioritize transmission of authenticated BSMs ahead of other BSMs that have not been authenticated.

In an aspect, the device 2 104 may authenticate the BSM 108 received from the device 1 102 and transmit the BSM 108 to the device 3 106. The device 3 106 may authenticate the BSM 108 received from the device 2 104. Accordingly, the device 3 106 may be granted local authority. The device 2 104 may then generate the BSM 112 for transmission to one or more devices (e.g., device 3 106). If the device 2 104 determines that the device 3 106 having local authority will transmit the BSM 108 at a future time, e.g., in a particular time slot, the device 2 104 may refrain from transmitting the BSM 112 in the particular time slot. Therefore, by refraining from transmitting the BSM 112, the device 2 104 may avoid consuming resources and reduce wireless traffic congestion to enable the device 3 106 to promptly and successfully transmit the BSM 108.

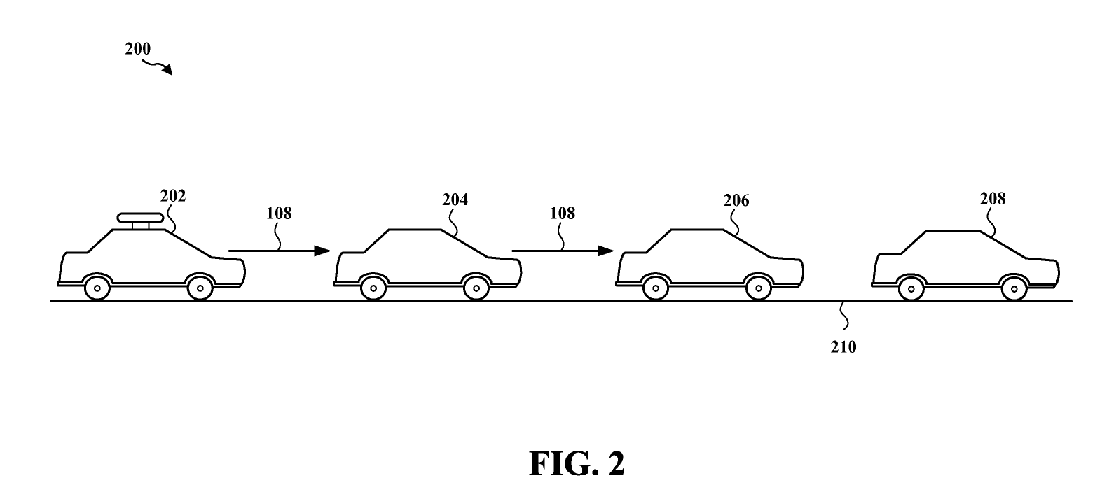

An example implementation of the communication system 100 will now be described with reference to FIG. 2. FIG. 2 is a diagram 200 illustrating BSM transmissions. FIG. 2 includes police vehicle 202 and vehicles 204, 206, and 208 travelling ahead of the police vehicle 202 on the street 210. For example, the device 1 102 may be installed in the police vehicle 202, device 2 104 may be installed in vehicle 204, and device 3 106 may be installed in vehicle 206. In this example, the police vehicle may be involved in a high speed pursuit of vehicle 208.

As shown in FIG. 2, the police vehicle 202 having authority to generate high priority BSMs may generate and transmit the BSM 108 to the vehicle 204. The BSM 108 may include public safety information that alerts vehicles traveling on the street 210 of the high speed pursuit. The vehicle 204 may receive the BSM 108 from the police vehicle 202 and may authenticate the BSM 108 by validating a signature key included in the BSM 108. For example, the vehicle 204 may validate the signature key of the BSM 108 by comparing a key stored in a memory (not shown in FIG. 2) of the vehicle 204 with the signature key of the BSM 108. If the key stored in the memory of the vehicle 204 matches the signature key of the BSM 108, the vehicle 204 may determine that the BSM 108 is a validated BSM. Accordingly, the vehicle 204 may be granted local authority and may transmit the BSM 108 to one or more vehicles, such as the vehicle 206, after the BSM 108 has been authenticated. Otherwise, if the signature key does not match the key stored in the memory of the vehicle 204, the vehicle 204 may discard the received BSM 108. The vehicle 206 may receive the BSM 108 from the vehicle 204 and determine the public safety information included in the BSM 108.

Therefore, the vehicle 204 may relay the BSM 108 received from the police vehicle 202 to the vehicle 206. In an aspect, the BSM 108 may include control information indicating the direction of the high speed pursuit. In such aspect, the vehicle 204 may determine a relative location of one or more vehicles in the vicinity of vehicle 204 and may transmit the BSM 108 to vehicles ahead of the vehicle 204 that are traveling in the same direction as the high speed pursuit. For example, the vehicle 204 may determine the relative location of the vehicle 206 using position information received in a BSM from the vehicle 206. The vehicle 204 may then transmit the BSM 108 to the vehicle 206 travelling in the same direction as the high speed pursuit.

In an aspect, the vehicle 204 may generate a BSM that is different from the BSM 108 for transmission to one or more vehicles (e.g., vehicle 206). In such aspect, if the vehicle 204 has authenticated the BSM 108 received from the police vehicle 202, the vehicle 204 may transmit the BSM 108 to vehicle 206 prior to transmitting the generated BSM.

In an aspect, the vehicle 204 may authenticate the BSM 108 from the police vehicle 202 and may transmit the BSM 108 to the vehicle 206. The vehicle 204 may then generate a BSM that is different from the BSM 108 for transmission to one or more vehicles (e.g., vehicle 206). If the vehicle 204 determines that the vehicle 206 will transmit the BSM 108 at a future time, e.g., in a particular time slot, the vehicle 204 may refrain from transmitting the generated BSM in the particular time slot.

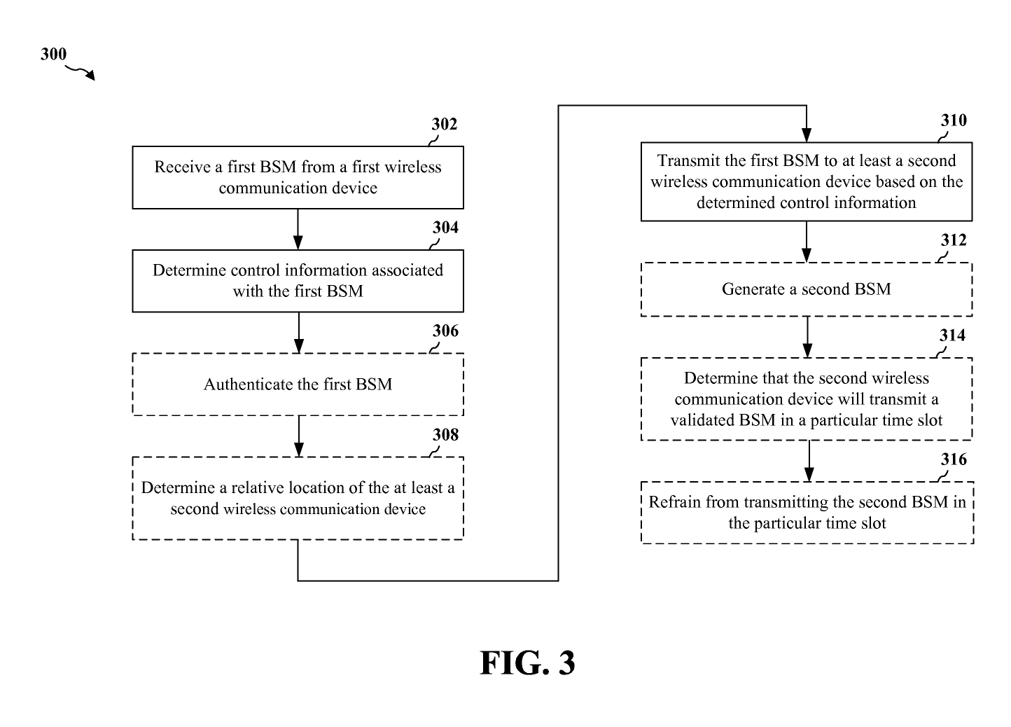

FIG. 3 is a flow chart 300 of a method of wireless communication. The method may be performed by a wireless communication device, such as the device 2 204 in FIG. 2. At step 302, the wireless communication device receives a first BSM from a first wireless communication device. For example, with reference to FIG. 1, the device 2 104 may receive the BSM 108 from device 1 102.

At step 304, the wireless communication device determines control information associated with the received first BSM. For example, with reference to FIG. 1, the device 2 104 may determine control information associated with the BSM 108 received from device 1 102. In an aspect, the control information may include public safety information, traffic delay information, detour information, a desired direction, a destination, and/or weather information.

At step 306, the wireless communication device authenticates the received first

BSM. In an aspect, the wireless communication device authenticates the first BSM by validating a signature key of the received first BSM. For example, with reference to FIG. 1, the device 2 104 may authenticate the BSM 108 from the device 1 102 by validating a signature key 110 of the BSM 108 received from the device 1 102. For example, the device 2 104 may validate the signature key 110 of the BSM 108 by comparing a key stored in a memory (not shown in FIG. 1) of the device 2 104 with the signature key 110. If the key stored in the memory of the device 2 104 matches the signature key 110, the device 2 104 may determine that the BSM 108 is a validated BSM.

At step 308, the wireless communication device determines a relative location of one or more wireless communication devices. For example, with reference to FIG. 1, the device 2 104 may determine the relative location of a device (e.g., device 3 106) using position information received in a BSM message from the device. For example, the relative location may be represented as GPS coordinates or as a direction with respect to the device 2 104, such as north or southwest.

At step 310, the wireless communication device transmits the received first BSM to one or more wireless communication devices based on the determined control information. In an aspect, the wireless communication device may transmit the received first BSM to one or more wireless communication devices after the received BSM has been authenticated. In another aspect, the wireless communication device may transmit the received first BSM to a wireless communication device based on the determined relative location of wireless communication device. For example, with reference to FIG. 2, the vehicle 204 may determine a relative location of one or more vehicles (e.g., vehicle 206) in the vicinity of vehicle 204 and may transmit the BSM 108 to vehicles located ahead of the vehicle 204 traveling in the same direction as the high speed pursuit. For example, the vehicle 204 may determine the relative location of the vehicle 206 using position information received in a BSM from the vehicle 206. The vehicle 204 may then transmit the BSM 108 to the vehicle 206 travelling in the same direction as the high speed pursuit.

At step 312, the wireless communication device generates a second BSM. For example, with reference to FIG. 1, the device 2 104 may generate the BSM 112 for transmission to one or more devices (e.g., device 3 106). In such aspect, if the device 2 104 has authenticated the BSM 108, the device 2 104 may transmit the BSM 108 to device 3 106 prior to transmitting the BSM 112.

At step 314, the wireless communication device determines that the second wireless device will transmit a validated BSM is a particular time slot.

At step 316, the wireless communication device refrains from transmitting the second BSM in the particular time slot. For example, with reference to FIG. 1, the device 2 104 may refrain from transmitting the BSM 112 in the particular time slot when the device 2 104 determines that the device 3 106 will transmit the BSM 108 in the particular time slot.

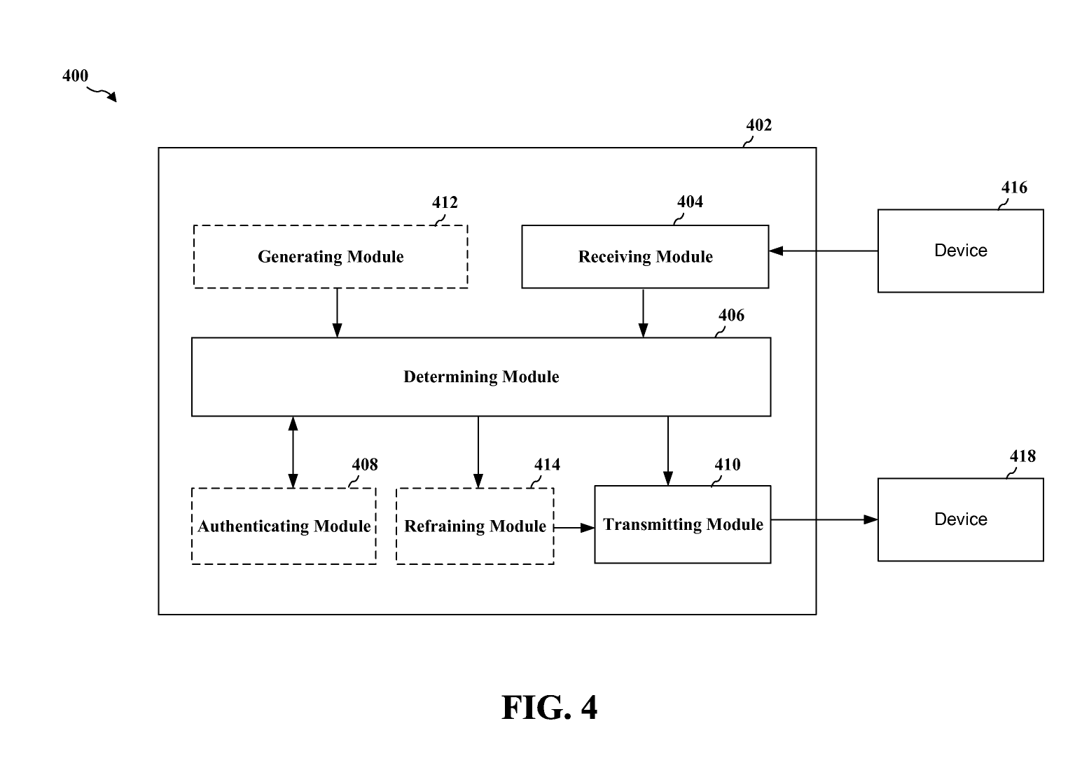

FIG. 4 is a conceptual data flow diagram 400 illustrating the data flow between different modules/means/components in an exemplary apparatus 402. The apparatus may be a wireless communication device, such as device 2 104 in FIG. 1. The apparatus includes a module 404 that receives a first BSM from a first wireless communication device (e.g., wireless communication device 416). The apparatus further includes a module 406 that determines control information associated with the first BSM, determines a relative location of the at least a second wireless communication device, and determines that the second wireless device will transmit a validated BSM in a particular time slot. The apparatus further includes a module 408 that authenticates the first BSM. In one configuration, the module 408 authenticates the first BSM by validating a signature key of the first BSM. The apparatus further includes a module 412 for generating a second BSM. The apparatus further includes a module 410 for transmitting the first BSM to at least a second wireless communication device (e.g., wireless communication device 416) based on the determined control information. For example, the control information may include public safety information, traffic delay information, detour information, a desired direction, destination, and/or weather information. In one configuration, the module 410 transmits the validated first BSM prior to the second BSM. In another configuration, the module 410 transmits the first BSM to the at least a second wireless communication device based on the determined relative location of the at least a second wireless communication device. The apparatus further includes a module 414 that refrains from transmitting the second BSM in the particular time slot based on the determination that the second wireless device will transmit the validated BSM in the particular time slot.

The apparatus may include additional modules that perform each of the steps of the algorithm in the aforementioned flow chart of FIG. 3. As such, each step in the aforementioned flow chart of FIG. 3 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

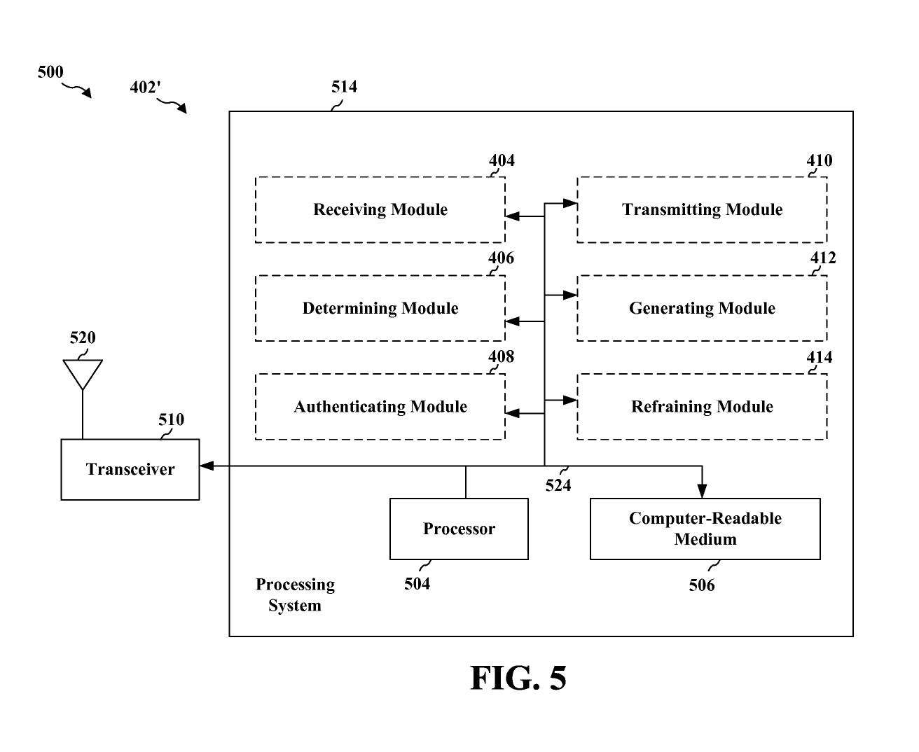

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware modules, represented by the processor 504, the modules 404, 406, 408, 410, 412, and 414, and the computer-readable medium 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the receiving module 404. In addition, the transceiver 510 receives information from the processing system 514, specifically the transmission module 410, and based on the received information, generates a signal to be applied to the one or more antennas 520. The processing system 514 includes a processor 504 coupled to a computer-readable medium 506. The processor 504 is responsible for general processing, including the execution of software stored on the computer-readable medium 506. The software, when executed by the processor 504, causes the processing system 514 to perform the various functions described supra for any particular apparatus. The computer-readable medium 506 may also be used for storing data that is manipulated by the processor 504 when executing software. The processing system further includes at least one of the modules 404, 406, 408, 410, 412, and 414. The modules may be software modules running in the processor 504, resident/stored in the computer readable medium 506, one or more hardware modules coupled to the processor 504, or some combination thereof.

In one configuration, the apparatus 402/402′ for wireless communication includes means for receiving a first BSM from a first wireless communication device, means for determining control information associated with the first BSM, means for transmitting the first BSM to at least a second wireless communication device based on the determined control information, means for authenticating the first BSM, means for authenticating the first BSM is configured to validate a signature key of the first BSM, means for generating a second BSM, means for determining that the second wireless device will transmit a validated BSM in a particular time slot, means for refraining from transmitting the second BSM in the particular time slot based on the determination that the second wireless device will transmit the validated BSM in the particular time slot, means for determining a relative location of the at least a second wireless communication device, wherein the first BSM is transmitted to the at least a second wireless communication device based on the relative location. The aforementioned means may be one or more of the aforementioned modules of the apparatus 402 and/or the processing system 514 of the apparatus 402′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication comprising:
receiving a first basic safety message (BSM) from a first wireless communication device;
determining control information associated with the first BSM; and
transmitting the first BSM to at least a second wireless communication device based on the determined control information.

2. The method of claim 1, further comprising authenticating the first BSM, wherein the first BSM is transmitted to the at least a second wireless communication device after the first BSM has been authenticated.

3. The method of claim 2, wherein authenticating the first BSM comprises validating a signature key of the first BSM.

4. The method of claim 3, further comprising generating a second BSM, wherein the validated first BSM is transmitted prior to the second BSM.

5. The method of claim 1, further comprising:
generating a second BSM;
determining that the second wireless device will transmit a validated BSM in a particular time slot; and
refraining from transmitting the second BSM in the particular time slot based on the determination that the second wireless device will transmit the validated BSM in the particular time slot.

6. The method of claim 1, further comprising determining a relative location of the at least a second wireless communication device, wherein the first BSM is transmitted to the at least a second wireless communication device based on the relative location.

7. The method of claim 1, wherein the control information in the first BSM comprises at least one of public safety information, traffic delay information, detour information, a desired direction, a destination, or weather information.

8. An apparatus for wireless communication, comprising:
means for receiving a first basic safety message (BSM) from a first wireless communication device;
means for determining control information associated with the first BSM; and
means for transmitting the first BSM to at least a second wireless communication device based on the determined control information.

9. The apparatus of claim 8, further comprising means for authenticating the first BSM, wherein the first BSM is transmitted to the at least a second wireless communication device after the first BSM has been authenticated.

10. The apparatus of claim 9, wherein the means for authenticating the first BSM is configured to validate a signature key of the first BSM.

11. The apparatus of claim 10, further comprising means for generating a second BSM, wherein the validated first BSM is transmitted prior to the second BSM.

12. The apparatus of claim 8, further comprising:
means for generating a second BSM;
means for determining that the second wireless device will transmit a validated BSM in a particular time slot; and
means for refraining from transmitting the second BSM in the particular time slot based on the determination that the second wireless device will transmit the validated BSM in the particular time slot.

13. The apparatus of claim 8, further comprising means for determining a relative location of the at least a second wireless communication device, wherein the first BSM is transmitted to the at least a second wireless communication device based on the relative location.

14. The apparatus of claim 8, wherein the control information in the first BSM comprises at least one of public safety information, traffic delay information, detour information, a desired direction, a destination, or weather information.

15. An apparatus for wireless communication, comprising:
a processing system configured to:
receive a first basic safety message (BSM) from a first wireless communication device;
determine control information associated with the first BSM; and
transmit the first BSM to at least a second wireless communication device based on the determined control information.

16. The apparatus of claim 15, the processing system further configured to authenticate the first BSM, wherein the first BSM is transmitted to the at least a second wireless communication device after the first BSM has been authenticated.

17. The apparatus of claim 16, wherein authentication of the first BSM comprises validating a signature key of the first BSM.

18. The apparatus of claim 17, the processing system further configured to generate a second BSM, wherein the validated first BSM is transmitted prior to the second BSM.

19. The apparatus of claim 15, the processing system further configured to:
generate a second BSM;
determine that the second wireless device will transmit a validated BSM in a particular time slot; and
refrain from transmitting the second BSM in the particular time slot based on the determination that the second wireless device will transmit the validated BSM in the particular time slot.

20. The apparatus of claim 15, the processing system further configured to determine a relative location of the at least a second wireless communication device, wherein the first BSM is transmitted to the at least a second wireless communication device based on the relative location.

21. The apparatus of claim 15, wherein the control information in the first BSM comprises at least one of public safety information, traffic delay information, detour information, a desired direction, a destination, or weather information.

22. A computer program product, comprising:
a computer-readable medium comprising code for:
receiving a first basic safety message (BSM) from a first wireless communication device;
determining control information associated with the first BSM; and
transmitting the first BSM to at least a second wireless communication device based on the determined control information.

23. The computer program product of claim 22, the computer-readable medium further comprising code for authenticating the first BSM, wherein the first BSM is transmitted to the at least a second wireless communication device after the first BSM has been authenticated.

24. The computer program product of claim 23, wherein authenticating the first BSM comprises validating a signature key of the first BSM.

25. The computer program product of claim 24, the computer-readable medium further comprising code for generating a second BSM, wherein the validated first BSM is transmitted prior to the second BSM.

26. The computer program product of claim 22, the computer-readable medium further comprising code for:
generating a second BSM;
determining that the second wireless device will transmit a validated BSM in a particular time slot; and
refraining from transmitting the second BSM in the particular time slot based on the determination that the second wireless device will transmit the validated BSM in the particular time slot.

27. The computer program product of claim 22, the computer-readable medium further comprising code for determining a relative location of the at least a second wireless communication device, wherein the first BSM is transmitted to the at least a second wireless communication device based on the relative location.

28. The computer program product of claim 22, wherein the control information in the first BSM comprises at least one of public safety information, traffic delay information, detour information, a desired direction, a destination, or weather information.
